(19) United States
(12) Patent Application Publication
(10) Pub. No.: US 2007/0272625 A1
(43) Pub. Date: Nov. 29, 2007

(54) Filtration system and method for implementing the same

(75) Inventor: Peter Moskun, Baie d'Urfe (CA)

Correspondence Address: IP LEGAL DEPARTMENT;TYCO FIRE & SECURITY SERVICES, ONE TOWN CENTER ROAD, BOCA RATON, FL, 33486, US

(73) Assignee: Ansul Canada Limited, Toronto (CA)

(21) Appl. No.: 11/805,548

(22) Filed: May 23, 2007

Related U.S. Application Data
(60) Provisional application No. 60/808,186, filed on May 24, 2006.

(51) Int. Cl. B01D 37/00

(52) U.S. Cl. 210/767; 210/521; 210/538; 210/136; 417/313; 210/220; 210/319

(57) ABSTRACT

A method and apparatus are disclosed for filtering out particles in a fluid, the method comprising providing the fluid, creating a turbulent flow in the fluid, and collecting the particles.

### CROSS REFERENCE TO RELATED APPLICATION

This application claims the benefit of U.S. Provisional patent application Ser. No. 60/808,186 entitled “Filtration system” that was filed on May 24, 2006, and which is hereby incorporated by reference.

### FIELD OF THE INVENTION

The invention relates to the field of filters. More precisely, this invention pertains to a filtration system and a method for implementing the same.

### BACKGROUND OF THE INVENTION

Water is an important resource used when dealing with the fighting of forest fires. Fire fighters use pumping units (typically an engine driving a pump end) to move water from a water source to the fire location. Typical water sources include, but are not limited to, natural water sources, such as rivers, lakes, ponds, streams, bogs, etc., and artificial water sources such as water trucks.

When drafting water from a natural water source, it is not uncommon to suck in particles such as rocks, sand, or the like. Obviously, these particles can be very damaging to the internal components of the pumping unit, resulting in reduced performance, and requiring in some cases a rebuild or even scrapping a pumping unit.

It is crucial that a pumping unit be operational and produce the highest amount of pressure possible when fighting fires.

To solve this problem, operators typically use a strainer attached to the end of the suction hose. However, if the strainer detaches from the end of the suction hose and falls to the bottom, then there is a great possibility that particles will be sucked in by the pump, resulting in pump-end damage.

This problem has been solved in some cases by placing a shovel on the water source bottom and placing a strainer on top of the shovel to prevent bottom sediments from being sucked into the pump.

Another solution has been to attach a flotation device to the strainer in order to prevent the strainer from sinking to the bottom of the water source where it could be in contact with the sediments.

While these prior art techniques may be efficient in some instances, in other instances, they do not solve the problem; particularly in cases where the water source itself contains particles, such as for instance glacial water which contains ice particles. In such cases, it becomes very difficult to avoid sucking harmful pump-damaging particles into the pumping unit. Separating the strainer from the bottom of the water source is not sufficient.

On the other hand, some operators have tried to use filtering elements to address this problem. However, since the flow of water in the suction hose connected to the pumping unit is high, the filtering element may quickly become clogged with particles, resulting in a rapid performance decrease of the pumping unit. Such loss in performance is not acceptable when dealing with forest fires.

There is a need for a filtration system that will overcome at least one of the above-mentioned drawbacks.

Features of the invention will be apparent from review of the disclosure, drawings and description of the invention below.

### BRIEF SUMMARY OF THE INVENTION

The invention provides a filtration apparatus for filtering out particles in a fluid, the apparatus comprising an inlet port for receiving the fluid, an outlet port for discharging a filtered fluid and a chamber in fluid communication with the inlet port and the outlet port, the chamber comprising means for creating a turbulent flow in the received fluid. Means for creating turbulent flow includes, but is not limited to, baffles and/or turbines. Trapping means is located downstream of the means for creating a turbulent flow and collects the particles in the chamber.

The invention further provides a method for filtering out particles in a fluid, the method comprising providing the fluid, creating a turbulent flow in the fluid and collecting the particles.

### BRIEF DESCRIPTION OF THE DRAWINGS

In order that the invention may be readily understood, embodiments of the invention are illustrated by way of example in the accompanying drawings.

FIG. 1 is a cross-sectional view of a three-stage filtration system according to one embodiment of the invention; the filtration system comprises, inter alia, a first trapping means, a second trapping means and a third trapping means;

FIG. 2 is a schematic diagram showing one embodiment of a pumping system comprising the filtration system disclosed in FIG. 1, wherein the filtration system is located upstream of a pumping unit;

FIG. 3 is a cross-sectional view of another embodiment of the invention having a two-stage filtration system; in this embodiment, the filtration system comprises a first turbine and a second turbine;

FIG. 4 is a front elevation view of a turbine element used in the embodiment of the filtration system disclosed in FIG. 3; and

FIG. 5 is a flowchart which shows one embodiment for filtering out particles of an incoming fluid according to one embodiment of the invention.

Further details of the invention and its advantages will be apparent from the detailed description included below.

### DETAILED DESCRIPTION

In the following description of various embodiments of the invention, references to the accompanying drawings are by way of illustration of an example by which the invention may be practiced. It will be understood that other embodiments may be made without departing from the scope of the invention disclosed.

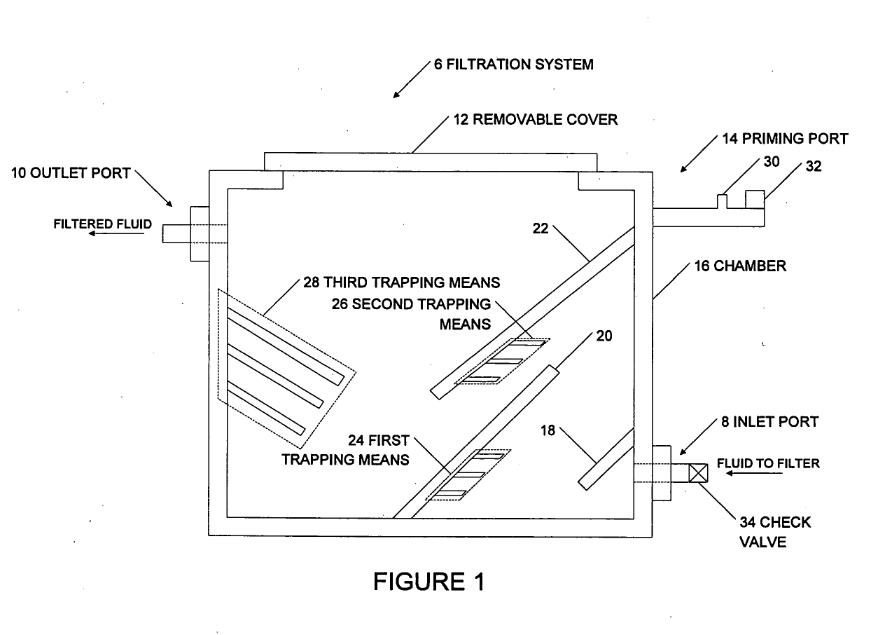

Now referring to FIG. 1, there is shown a three-stage filtration system 6 according to one embodiment of the invention.

The filtration system 6 comprises an inlet port 8, a chamber 16 and an outlet port 10.

The chamber 16 comprises means for creating a turbulent flow and trapping means located downstream of the means for creating a turbulent flow.

More precisely, the chamber 16 comprises a first baffle for creating a turbulent flow 18, a second baffle for creating a turbulent flow 20, and a third baffle for creating a turbulent flow 22. The chamber 16 further comprises a first trapping means 24, a second trapping means 26 and a third trapping means 28.

The inlet port 8 receives a fluid comprising particles and is in fluid communication with the chamber 16.

The outlet port 10 discharges a filtered fluid originating from the chamber 16 and is in fluid communication with the chamber 16. Each of the first baffle for creating a turbulent flow 18, the second baffle for creating a turbulent flow 20 and the third baffle for creating a turbulent flow 22 creates a corresponding turbulent flow in the incoming fluid.

Some particles, because of their respective inertia created by their corresponding weight, cannot navigate as rapidly as the fluid and are regrouped into at least one region located downstream of the corresponding baffle for creating a turbulent flow.

By positioning the trapping means adequately, it is therefore possible to collect the particles.

Now referring back to FIG. 1, each of the first trapping means 24, the second trapping means 26 and the third trapping means 28 may collect particles.

In the embodiment disclosed in FIG. 1, the first trapping means 24 is located downstream of the first baffle for creating a turbulent flow 18, while the second trapping means 26 is located downstream of the second baffle for creating a turbulent flow 20 and the third trapping means 28 is located downstream of the third baffle for creating a turbulent flow.

It will be therefore appreciated by the skilled addressee that in this embodiment there is disclosed a three-stage filtration system. It should be clearly understood, however, that the filtration system may have any number of stages depending on a particular application.

Moreover, in the embodiment disclosed in FIG. 1, the inlet port 8 is located near the bottom of the chamber 16 while the outlet port 10 is located near the top of the chamber 16. Since the outlet port 10 is located higher than the inlet port 8, the particles require extra energy to overcome the difference in height and heavier particles may therefore not able to reach the outlet port 10 and are therefore being filtered de facto at a lower portion of the chamber 16.

It will be further appreciated that in the embodiment disclosed in FIG. 1, a priming port 14 is provided for priming the filtration system 6.

The priming port 14 comprises an inlet 30 and a pressure relief valve 32. Both the inlet 30 and the pressure relief valve 32 are in fluid communication with the chamber 16. A priming pump may discharge water to the filtration system 6 via the outlet 30.

On the other hand, the pressure relief valve 32 ensures that during shut-off conditions the pumping unit is not damaged, because allowing the pump to operate at shut-off for an extended period of time would result in the pumping unit being damaged. “Shut-off” is a condition wherein the pumping unit is operating but the flow of water has been stopped, for example by closing a nozzle or valve at the end of the discharge hose. When the flow of water is stopped but the pump continues to operate, friction between the water and the pump's internal spinning components increases resulting in a higher temperature, which further results in an increase of pressure. If this condition persists, the pumping unit could be damaged and the hose may rupture.

Alternatively, the filtration system 6 may be primed by removing the removable cover 12 and filling the filtration system 6 with the liquid. The check valve 34 prevents the liquid from draining out through the inlet port 8.

Still referring to the embodiment disclosed in FIG. 1, the first baffle for creating a turbulent flow 18 is located proximate to the inlet port 8 opening inside the chamber 16. The first trapping means 24 is secured to the second baffle for creating a turbulent flow 20 while the second trapping means 26 is secured to the third baffle for creating a turbulent flow 22 and the third trapping means 28 is secured to a wall of the chamber 16.

Each of the first trapping means 24, the second trapping means 26 and the third trapping means 28 comprises at least one particle trap in the embodiment disclosed in FIG. 1.

The skilled addressee will appreciate that various shapes may be used for the baffle for creating a turbulent flow.

It will be further appreciated that the filtration system 6 may be opened or disassembled by an operator for cleaning purposes.

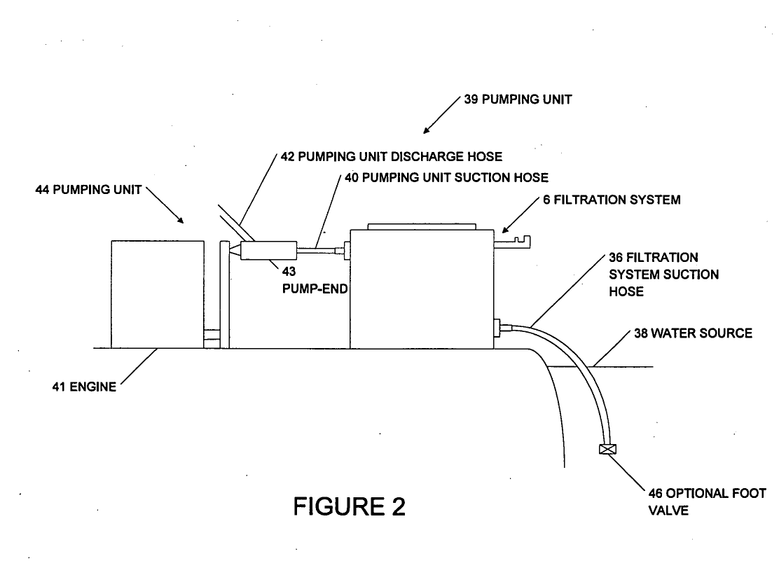

Now referring to FIG. 2, there is shown one embodiment of a pumping system 39 where the filtration system 6 disclosed in FIG. 1 is advantageously used.

The pumping system 39 comprises the filtration system 6, a pumping unit 44 comprising an engine 41 and pump-end 43, a filtration system suction hose 36, a pumping unit suction hose 40 and a pumping unit discharge hose 42.

The filtration system 6 is located upstream of the pumping unit 44 and is connected with it using the pumping unit suction hose 40. The filtration system 6 drafts the water from the water source 38 using the filtration system suction hose 36.

It will be appreciated that in order to operate the pumping system 39 various methods may be used to prime the pumping system 39 as explained above.

For instance, an operator may attach a priming pump to the system.

The filtration system suction hose may further comprise an optional foot valve at its end to enable the priming of the pumping system 39.

Alternatively, in a second embodiment, the pumping system 39 may be primed by an operator by removing the removable cover 12 shown in FIG. 1 and filling up the filtration system 6 with a liquid. In such embodiment, the pumping system 39 would be primed and all suction hoses would be ready for operation.

Alternatively, in a third embodiment, the filtration system 6 may be primed using the built-in check valve 34 shown in FIG. 1 and the optional foot valve 46 shown in FIG. 2.

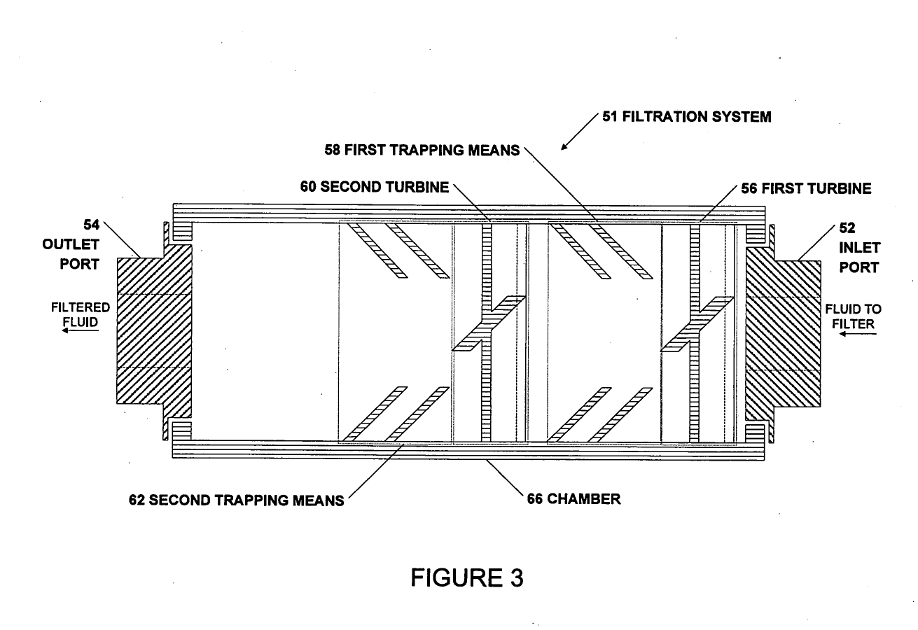

Now referring to FIG. 3, there is shown an embodiment of a two-stage filtration system 51.

In this embodiment, the filtration system 51 comprises an inlet port 52, a chamber 66, and an outlet port 54.

The chamber 66 comprises a first means for creating a turbulent flow which is a first turbine element 56, a first trapping means 58, a second means for creating a turbulent flow which is a second turbine element 60 and a second trapping means 62.

In the embodiment disclosed in FIG. 3, the filtration system 51 has a cylindrical shape and the first trapping means 58 and the second trapping means 62 are torus-shaped and mounted on the inner surface of the chamber 66. Alternatively, the filtration system 51 may have a rectangular or other shape.

The inlet port is in fluid communication with the chamber 66. The outlet port 54 is in fluid communication with the chamber 66. The incoming fluid enters at the inlet port 52 and flows into the chamber 66. The fluid then enters the first turbine 56 which creates a vortex. Because of the vortex, the particles comprised in the liquid are projected towards the inside wall of the chamber 66 and are trapped in the first trapping means 58 which is positioned on the wall of the chamber 66. The fluid then enters a second turbine 60 which creates another vortex, which again projects the particles towards the inside wall of the chamber 66. The particles are then trapped in the second trapping means 62, which is positioned on the inside wall of the chamber 66. The fluid is discharged from the chamber 66 through the outlet port 54. It will be appreciated by the skilled addressee that a pressure relief valve and a priming port which may or not have a built-in check valve, may be used as part of the filtration system 51.

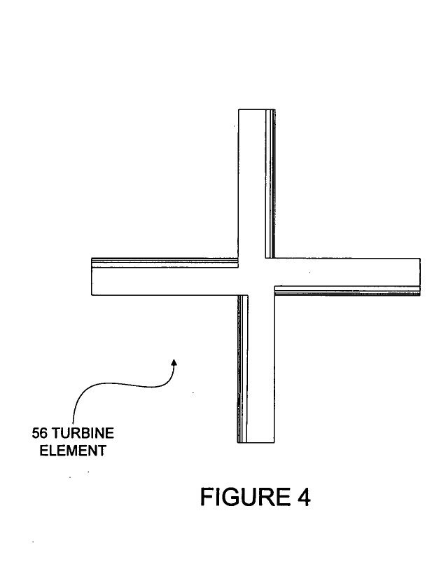

Now referring to FIG. 4, there is shown one embodiment of a turbine element 56 used to create a vortex. In this embodiment, the turbine element 56 has a cross shape. The skilled addressee will appreciate that various other shapes may be used to create a turbulent flow. It will be appreciated that the shape disclosed provides a particular type of turbulent flow also known as a vortex and that the trapping means is positioned according to the shape of the means to create a turbulent flow as well as according to a type of particle to be trapped.

Moreover, the skilled addressee will appreciate that because the turbine element 56 is immobile in the chamber, the filtering out of the particles before entering the pumping unit does not reduce the performance of the pump.

It should be further appreciated that while a priming port and a check valve are not shown in FIG. 4, a priming port and/or a check valve may be advantageously used in order to prime the filtration system 51.

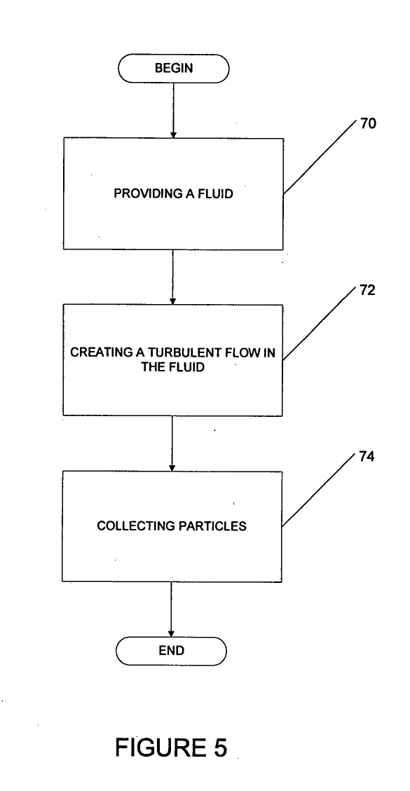

Now referring to FIG. 5, there is shown one embodiment of a method for collecting particles in a fluid to filter.

According to step 70, a fluid is provided. In one embodiment, the fluid is water.

According to step 72, a turbulent flow is created in the fluid. In one embodiment, the turbulent flow is generated using means for generating a turbulent flow. The means for generating the turbulent flow may be a turbine, a baffle, or any suitable element for disturbing the flow of the fluid.

According to step 74, the particles are collected. Again, it will be appreciated by the skilled addressee that various elements may be used to collect the particles. It will be appreciated by the skilled addressee that providing a filtration apparatus without a filtering element is of great advantage. Moreover, the skilled addressee will appreciate that in this embodiment, the filtration system may be cleaned after each use or as needed. The skilled addressee will also appreciate that a built-in check valve may be used in order to adequately prime the filtration apparatus.

It will be appreciated that the location of the trapping means provided depends on the size or weight of the particles to be collected.

Accordingly, various trapping means may be positioned strategically, each for collecting a given type of particles.

It will be further appreciated that the filtration system disclosed may be made of various materials such as, but not limited to, aluminum, polyvinyl chloride (PVC) or the like.

Although the above description relates to a specific preferred embodiment as presently contemplated by the inventor, it will be understood that the invention in its broad aspect includes mechanical and functional equivalents of the elements described herein.

1. A filtration apparatus for filtering out particles in a fluid, the apparatus comprising:
an inlet port for receiving said fluid;
an outlet port for discharging a filtered fluid;
a chamber in fluid communication with said inlet port and said outlet port, said chamber comprising
means for creating a turbulent flow in the received fluid; and
trapping means located downstream of said means for creating a turbulent flow, said trapping means collecting said particles in said chamber.

2. The filtration apparatus as claimed in claim 1, wherein said fluid is a liquid.

3. The filtration apparatus as claimed in claim 2, further comprising a priming port in fluid communication with said chamber, said priming port receiving a liquid for priming said filtration apparatus.

4. The filtration apparatus as claimed in claim 1, wherein said means for creating a turbulent flow comprises at least one baffle.

5. The filtration apparatus as claimed in claim 4, wherein said trapping means comprises at least one pocket.

6. The filtration apparatus as claimed in claim 1, wherein said chamber comprises more than one means for creating a turbulent flow, each of the more than one means for creating a turbulent flow receiving a corresponding flow and generating turbulences in said received corresponding flow, said chamber further comprising more than one trapping means, each located downstream of a corresponding means for creating a turbulent flow.

7. The filtration apparatus as claimed in claim 2, wherein said inlet port is located at a bottom end of said chamber.

8. The filtration apparatus as claimed in claim 2, wherein said outlet port is located at a top end of said chamber.

9. The filtration apparatus as claimed in claim 2, wherein said outlet port is at a higher elevation than the inlet port.

10. The filtration apparatus as claimed in claim 2, wherein said inlet port further comprises a check valve.

11. The filtration apparatus as claimed in claim 1, wherein said chamber comprises a removable cover.

12. The filtration apparatus as claimed in claim 1, wherein said chamber is made of one of polyvinyl chloride and aluminum.

13. The filtration apparatus as claimed in claim 2, wherein said means for creating a turbulent flow comprises a turbine element.

14. The filtration apparatus as claimed in claim 13, wherein said turbine element has a cross-shape.

15. The filtration apparatus as claimed in claim 14, wherein said turbine element is immobile.

16. A method for filtering out particles in a fluid, the method comprising:
providing said fluid;
creating a turbulent flow in said fluid; and
collecting said particles in said turbulent flow.

17. The method as claimed in claim 16, wherein said fluid is a liquid.

18. The method as claimed in claim 17, wherein said providing of said fluid comprises performing a priming.

19. The method as claimed in claim 17, wherein said creating of said turbulent flow comprises generating a vortex.

20. The method as claimed in claim 16, wherein said creating of said turbulent flow and said collecting of said particles is performed a given number of times.

21. A pumping system for pumping water to a given location from a water source comprising particles, said pumping system comprising:
a filtration system as claimed in claim 2;
a filtration system suction hose connected at one end to the filtration system and at another end to the water source;
a pumping unit for pumping water from said water source;
a pumping unit suction hose connected at one end to the filtration system and at another end to the pumping unit; and
a pumping unit discharge hose connected at one end to the pumping unit and delivering at another end said water to said given location.
